(19) United States
(12) Patent Application Publication
(10) Pub. No.: US 2010/0094656 A1
(43) Pub. Date: Apr. 15, 2010

(54) Physician documentation workflow management methods

(75) Inventor: Reid Conant, Carlsbad, CA (US)

Correspondence Address: CATALYST LAW GROUP, APC, 9710 SCRANTON ROAD, SUITE S-170, SAN DIEGO, CA, 92121, US

(73) Assignee: Conant and Associates, Inc., Carlsbad, CA (US)

(21) Appl. No.: 12/587,565

(22) Filed: Oct. 7, 2009

Related U.S. Application Data
(60) Provisional application No. 61/103,516, filed on Oct. 7, 2008.

(51) Int. Cl. G06Q 50/00; G06Q 10/00; G06F 17/00; G06F 3/048

(52) U.S. Cl. 705/3; 715/226; 715/770

(57) ABSTRACT

Improved systems and methods for collecting Protected Health Information (PHI) with or without the assistance of a physician scribe are described. Documenting a patient encounter utilizing a template-based charting system (either electronic or paper-based), and the tracking of this document status and patient clinical status throughout the encounter, for purposes of managing multiple patients and multiple patients' documents, as well as improved communication between providers and assistants. The systems and methods of this invention generally comprise an electronic records system for creating and maintaining information in electronic records; patient tracking system (either computerized or not) for managing tasks specific to provider documentation of specific clinical care actions and patient clinical status; complimentary utilization of medical history questionnaires which are designed to correlate with template-based charting tools; methods of communication between provider assistants (including physician assistants, nurses, secretaries, scribes, patients, or other assistants) to convey the status of the collection and management of the PHI, including patient history, patient examination, testing results, medical decision making, patient disposition plan, follow-up information and other elements of provider charting of PHI; sequence of patient tracking indicators that represent steps in the care of the patient, status of the document, and clinical or documentation-related tasks for completion by providers or provider assistants; improvements on a real-time compliance system for identifying the specific stage or status of each electronic record, and allowing providers and assistants to track this completion status, thereby streamlining documentation and compliance workflows.

### RELATED APPLICATIONS

This application claims the benefit of priority to U.S. Provisional Patent Application Ser. No. 61/103,516 filed on Oct. 7, 2009, by this same inventor for an invention entitled “Physician Documentation Workflow Management Methods”, and currently co-pending. A complete copy of the Provisional Patent Application is attached hereto as Appendix 1, and fully incorporated herein by this reference.

### FIELD OF THE INVENTION

The present invention relates generally to the systems and methods utilized by physicians in the documentation and verification of performed medical treatments. The present invention is more particularly, though not exclusively, related to a systematic method for facilitating the performance, and accurate documentation, of medical treatments involving multiple treatment providers and support staff in a fast-paced, high-volume emergency room environment.

### BACKGROUND OF THE INVENTION

Medical information relating to a patient's care has been collected for centuries. This information is contained in a medical record allows a patient's health care providers to quickly learn the patients' prior medical history, and thereby provides a high level of continuity of care to the patient. This medical record may also serve several other functions, such as providing a basis for planning the patient's future care, and documenting important communication between the patient's primary health care provider and any other health professionals that may be contributing to the patient's care. In some cases, the medical file can protect the legal interest of the patient and the health care providers responsible for the patient's care, and provides historical documentation of the care and services provided to the patient.

Traditionally, medical records have been written on paper and kept in folders. These folders are typically divided into useful sections, with new information added to each section chronologically as the patient experiences new medical issues. While these paper records have sufficed for some time, the creation and maintenance of paper files is extremely time consuming, particularly since these files are extremely detailed, and are often repetitive between patients resulting in duplicate efforts by the physician and his staff. Also, since the task of completing a medical chart is so time consuming, the treating physician often makes brief notes during an examination, only to return to the file hours, if not days later, to complete the treatment notes. Despite the physician's best efforts, the delay often results in inaccurate or incomplete patient medical files.

Over the years, various attempts have been made to overcome the physician's challenges to the creation and maintenance of accurate medical records. One such attempt included assigning a personal transcriptionist, often called a scribe, to accompany the physician during his patient visits. A scribe works side by side with a doctor as a personal documentation assistant. The scribe accompanies the doctor into the patient room, taking notes to document completely the physician-patient encounter. Additionally, the scribe assists the physician with other tasks that will make the patient encounter more efficient, such as documenting results of labs, x-rays, and consultations.

There are many benefits of utilizing a scribe, such as allowing physicians to maintain eye contact with patients instead of focusing on a clipboard or medical file, and they can spend more time on patient care since they don't have to spend their valuable time charting. Most importantly, the medical record is typically more complete than if the physician maintained the chart without the assistance of a scribe.

While the transcriptionist clearly provided some very necessary assistance to the physician, the process of data collection still required a very hands-on approach by the physician to ensure all data was collected, and all aspects of the patient's treatment were satisfied.

Along with the computer age came the introduction of electronic medical records. The introduction of electronic medical records has not only changed the format of medical records, has increased accessibility and portability of medical files, and is becoming increasingly popular. For example, in the United States, approximately one-quarter of office-based physicians reported using fully or partially electronic medical record systems (EMR) in 2005. However, less than 10% of these physicians actually have a “complete EMR system”, with all four basic functions deemed minimally necessary for a full EMR: computerized orders for prescriptions, computerized orders for tests, reporting of test results, and physician notes. The popularity of electronic medical records will surely increase in the near future as the American Recovery and Reinvestment Act of 2009 has set aside approximately $19 billion for physicians to adopt electronic medical record systems.

One popular electronic medical record system is Glance Networks, Inc.'s Emergency Care Documentation Systems (ECDS)'s electronic medical system, EmpowER™. EmpowER tracks patients from the initial triage through final discharge. This system effectively replaces outdated handwritten charts, and helps to eliminate incomplete patient records, delays in treatment, and errors caused by illegible handwriting. This electronic documentation system, however, fails to provide verification steps that ensure the electronic medical record is completed timely and fully. Thus, without a specific step-by-step analysis of the chart by the physician, the patient's record is often inaccurate and incomplete.

Another electronic medical record software system is FirstNet, and is healthcare information technology software vendor Cerner's online template-based physician documentation system. This system provides a multi-patient overview of the status of each patient. For discussion and background purposes, an exemplary view of the Cerner system is shown in FIG. 1, marked PRIOR ART.

The electronic templates in the FirstNet system are generated based on patient's age, presenting problems and gender. Referring to FIG. 1, the exemplary screen shot of a portion of an abdominal pain electronic template. Each template has specific paragraph levels, sentence levels, and specific terms that can be circled or backslashed to include that specific information as a pertinent positive or negative in the patient's chart. (e.g., The above example shows that the history source was the patient and NOT the family. The mode of arrival was walking.)

Throughout the course of the patient's stay in the emergency department, the patient's chart is completed by the provider based on history, physical examination, results of laboratory and other studies, medical decision-making or thought process of the physician, and final plan or disposition. Typically in the emergency department any given physician is caring for multiple patients at any one time, with each patient chart at a different stage of documentation. For example, one patient may have just arrived to the ED and his or her chart has just been started, whereas another patient may have been interviewed and examined and the chart has a history and physical completed however the patient's results are still pending and therefore laboratory and radiology studies have not yet been entered into the chart. Another patient may have all results returned in the chart completed, with remaining documentation to include the physician's medical decision-making as well as the physician's plan of care and disposition.

As described above, there are many challenges inherent in a fast-paced, high-volume medical practice such as an emergency room. One of the most significant challenges is in the accurate and timely recordation of patient treatment amongst all treatment providers. In order to maintain consistent communication among the various providers, and to optimize the efficiency of the patient tracking system, a novel document status tracking system was developed and will be described here.

### SUMMARY OF THE INVENTION

The present invention described in this patent application facilitates the communication between the physician and his or her assistant who may be completing the electronic documentation based on the physician's interview, physical examination, and other elements of patient care delivery, as well as a means to track in real-time the status of each patient chart, down to specific documentation-related tasks.

The physician scribe or other assistant is trained in basic medical terminology, recording of history, physical examination, and chart completion, as well as a basic education in the processes of the functioning emergency department. The scribe accompanies the physician during his or her shift, assisting the physician with the more clerical elements of documentation, allowing the physician to focus his or her attention on tasks that require physician-level training.

A predetermined set of tasks are specified for the scribe to monitor and perform which, in combination with the computer system of the present invention, provides a verification that each of these predetermined tasks is completed, thereby ensuring the completeness and accuracy of the patient's medical record. Specific documentation tasks may be grouped together and identified by icons, and each icon represents one or more tasks which must be completed prior to advancing to the next group of tasks. In some cases, the completion of the task advances the scribe to the next set of tasks, and in other cases, the scribe must manually indicate completion of a task.

### BRIEF DESCRIPTION OF THE DRAWINGS

The nature, objects, and advantages of the present invention will become more apparent to those skilled in the art after considering the following detailed description in connection with the accompanying drawings, in which like reference numerals designate like parts throughout, and wherein:

FIG. 1 is a view of a Prior Art electronic medical record system;

FIG. 2 is a system level diagram showing the computer system of the present invention having a server in communication with a variety of peripheral devices, remote computer stations for Physicians, Scribes, Nurses, etc., and a patient tracking board;

FIG. 3 is a top plan view of an exemplary electronic media device, such as a compact disc (CD) upon which the methods of the present invention are stored;

FIG. 4 is a computer screen representation of a patient tracking system of the present invention having a PNED column containing scribe activities for multiple patients that are representative of the present invention;

FIG. 5 is an enlarged view of a computer screen representation of the patient tracking system of the present invention showing a PNED column, and specific scribe tasks related to each of a multitude of patients;

FIG. 6 is a computer screen representation of the scribe tasks of the present invention showing the request, and boxes in which the scribe can check to represent the start and completion of each task;

FIG. 7 is a flow chart of the operation of the system of the present invention showing the patient's treatment and documentation beginning at arrival, and continuing through assignment of a scribe, preliminary examinations, tests and procedures, diagnosis, and review and release by the attending physician, all documented by the scribe in near real-time;

FIG. 8 is a flow chart of the operation of the system of the present invention showing the icon number 2 tasks of initial electronic medical record building by the scribe, including the delivery and entry of patient questionnaire data, and documentation of the patient's prior medical history;

FIG. 9 is a flow chart of the operation of the system of the present invention showing the icon number 3 tasks of documenting the patient history, examination, ordering of any medications, ordering of any tests and consultations;

FIG. 10 is a flow chart of the operation of the system of the present invention showing the icon number 4 tasks of documenting all tests are performed and results documented, any re-examinations are documented, medications administered, consultations and opinions documented, and all results from laboratory tests are documented;

FIG. 11 is a flow chart of the operation of the system of the present invention showing the icon number 5 tasks of disposition decision and diagnosis by the MD documented, critical care notes documented, any necessary patient education and follow up instructions are given and documented, and all scribe tasks are completed and documented;

FIG. 12 is a flow chart of the operation of the system of the present invention showing the icon number 6 tasks of the MD reviewing the patient file, MD documentation of any medical decision making opinion, verification that the file is complete, and then the MD signs the patient record;

FIG. 13 is a flow chart of the operation of the system of the present invention showing the exemplary method for ordering of prescription medication including the entry of the prescription, the setting of the prescription icon on the tracking board, the ordering of the medication, administration of the medication, and the documentation by the scribe that the medication was administered to the patient;

FIG. 14 is a flow chart of the operation of the system of the present invention showing the patient tasks beginning with patient check-in, including assigning a bed and giving the patient a questionnaire, and then documenting that the questionnaire was provided;

FIG. 15 is a flow chart of the operation of the system of the present invention showing a more detailed example of a prescription order utilizing the documentation method of the present invention having intermediate icon status indicators, and including the annotations on several tracking boards for the MD, nurse, scribe, etc., and the setting and clearing of icons indicating the level of completion of the task of prescribing, ordering, receiving and administering the medication to the patient;

FIG. 16 is a flow chart of the operation of the system of the present invention showing the method steps for the ordering, administering and documentation of a typical EKG for a patient, including the MD ordering the EKG, the technician performing the EKG and returning the results to the MD for review and analysis, and the scribe documenting the computerized results and the MD's interpretations, corrections, or variances, as well as other predetermined EKG data; and

FIG. 17 is a table showing the various scribe stage indicators utilized on the tracking boards, and including the name of the stage, the tracking board indicator for that stage, the triggering or start of the stage, and the completion of the stage.

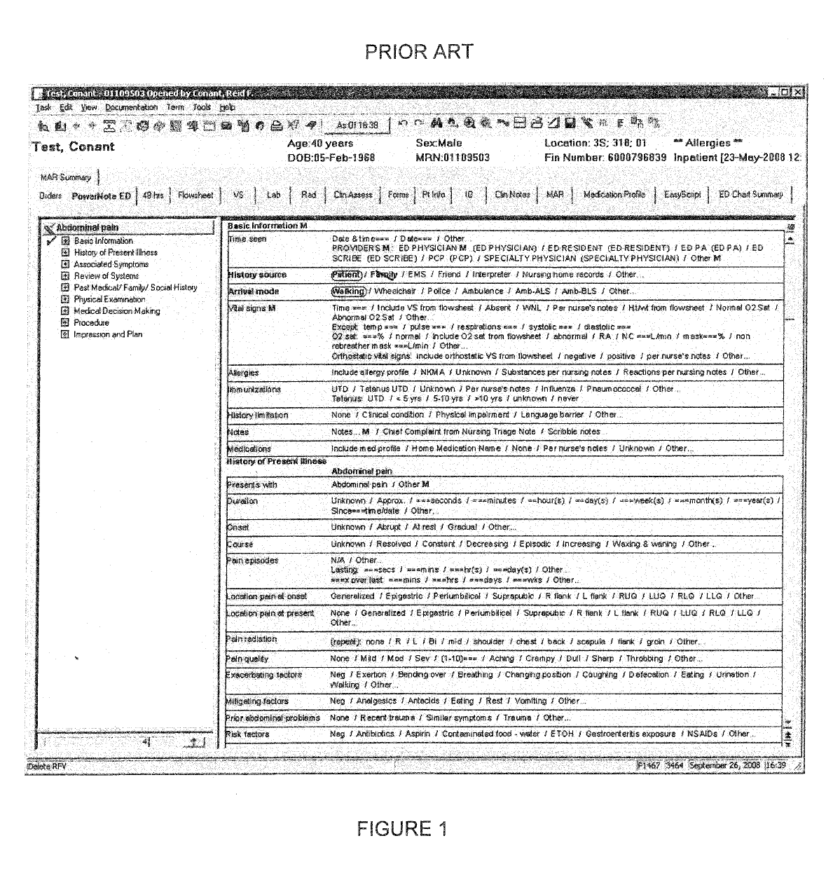

### DETAILED DESCRIPTION OF A PREFERRED EMBODIMENT

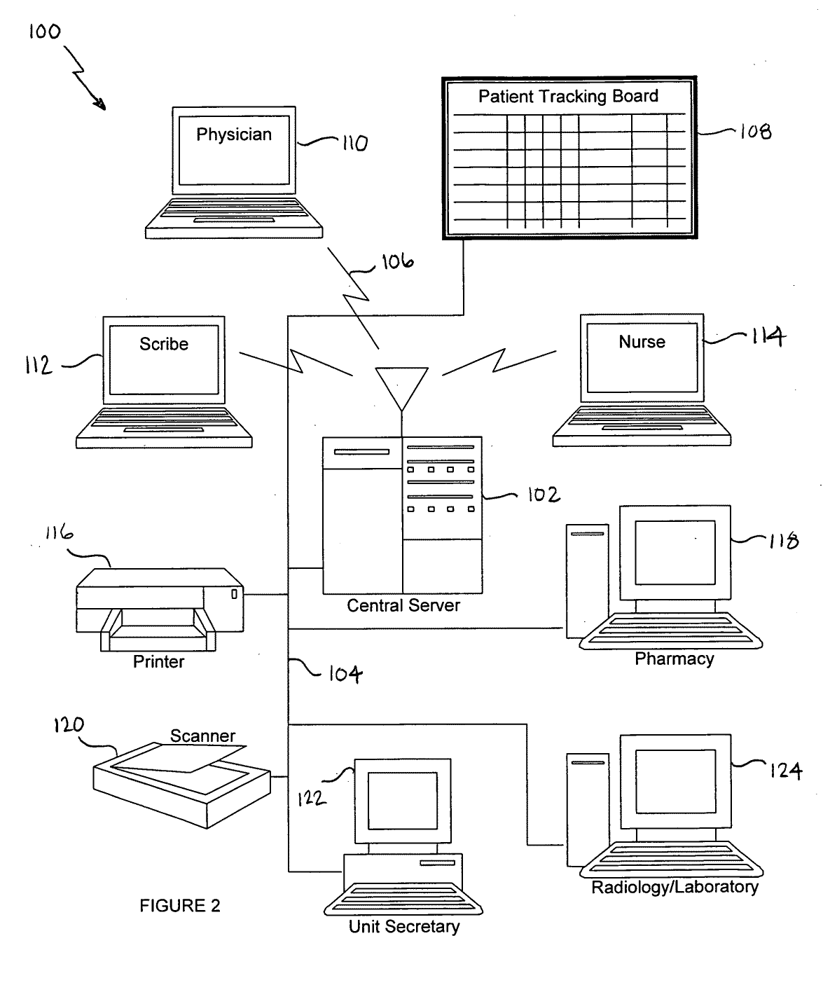

FIG. 2 is a system level diagram showing the computer system of the present invention having a server in communication with a variety of peripheral devices, remote computer stations for Physicians, Scribes, Nurses, etc., and a patient tracking board;

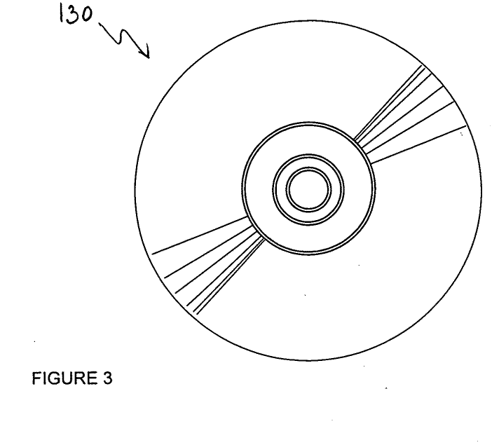

FIG. 3 is a top plan view of an exemplary electronic media device, such as a compact disc (CD) upon which the methods of the present invention are stored;

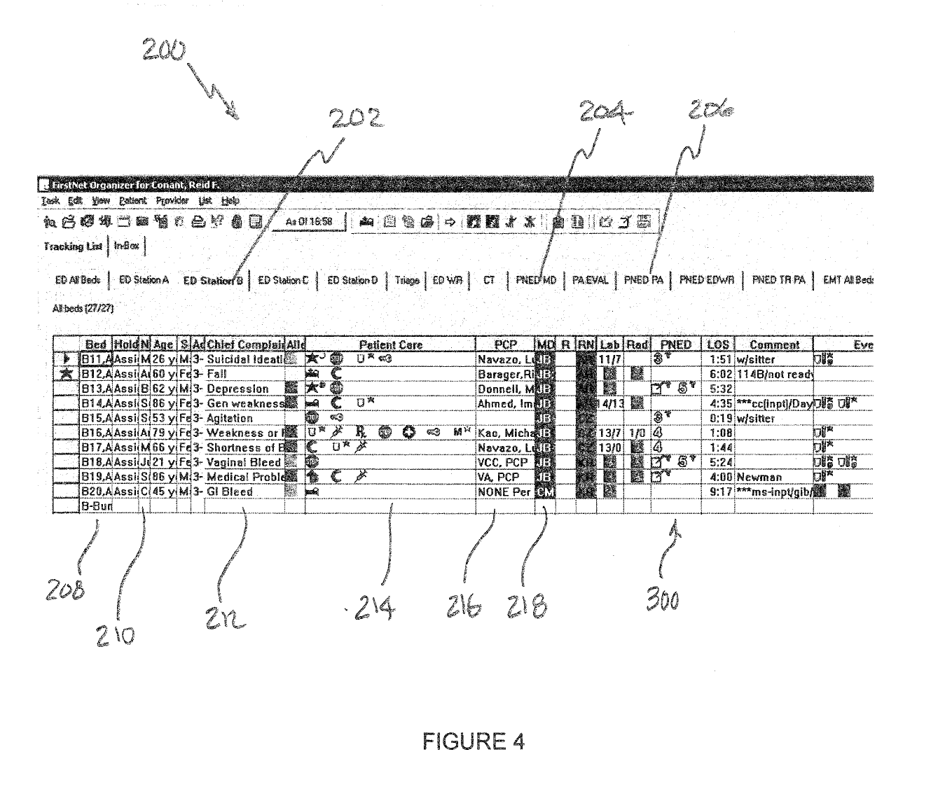

FIG. 4 is a computer screen representation of a patient tracking system of the present invention having a PNED column containing scribe activities for multiple patients that are representative of the present invention;

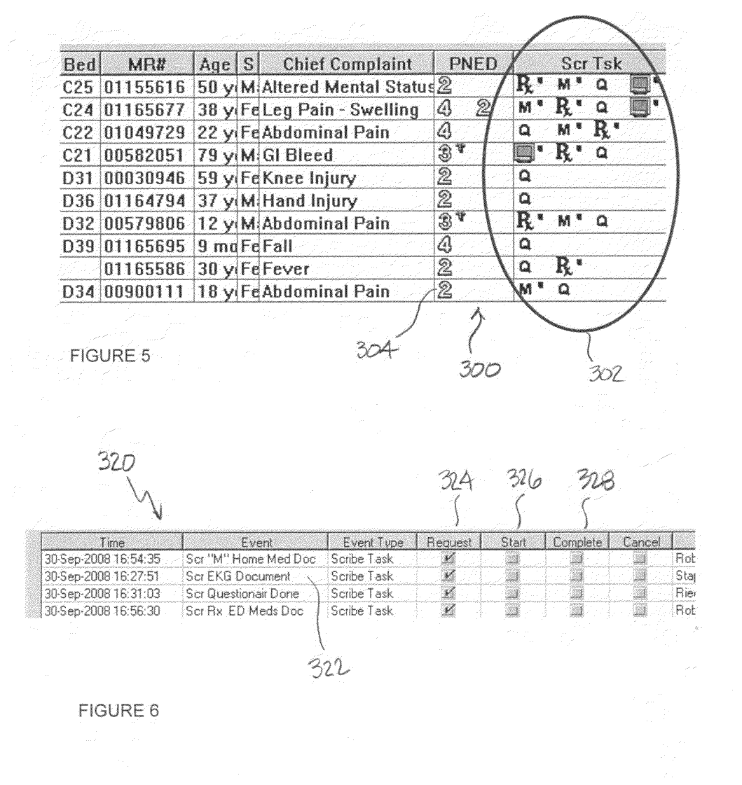

FIG. 5 is an enlarged view of a computer screen representation of the patient tracking system of the present invention showing a PNED column, and specific scribe tasks related to each of a multitude of patients;

FIG. 6 is a computer screen representation of the scribe tasks of the present invention showing the request, and boxes in which the scribe can check to represent the start and completion of each task;

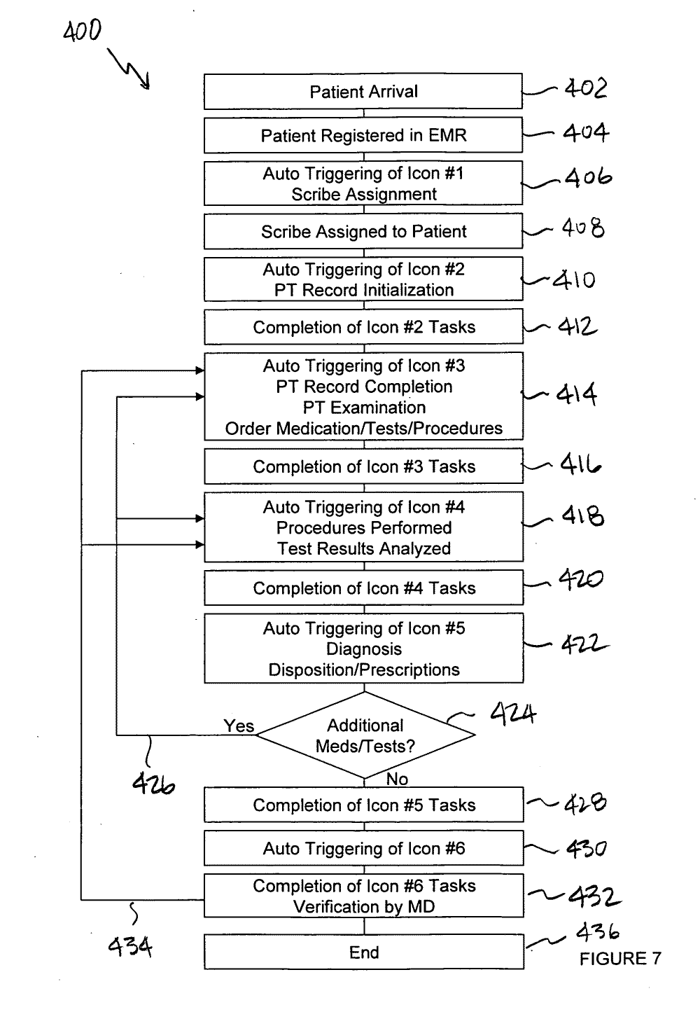

FIG. 7 is a flow chart of the operation of the system of the present invention showing the patient's treatment and documentation beginning at arrival, and continuing through assignment of a scribe, preliminary examinations, tests and procedures, diagnosis, and review and release by the attending physician, all documented by the scribe in near real-time;

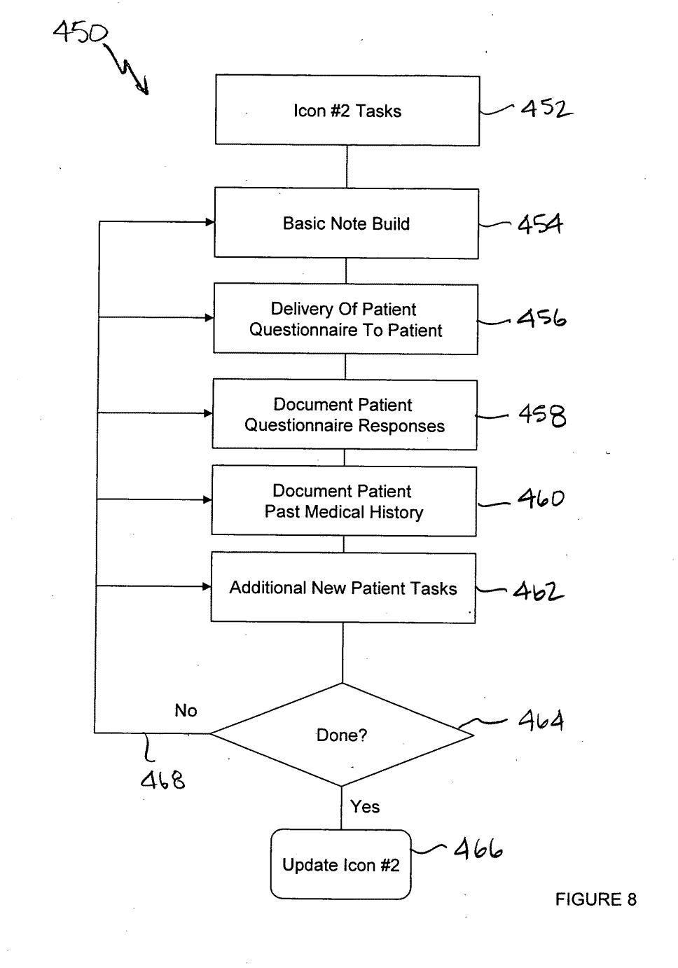

FIG. 8 is a flow chart of the operation of the system of the present invention showing the icon number 2 tasks of initial electronic medical record building by the scribe, including the delivery and entry of patient questionnaire data, and documentation of the patient's prior medical history;

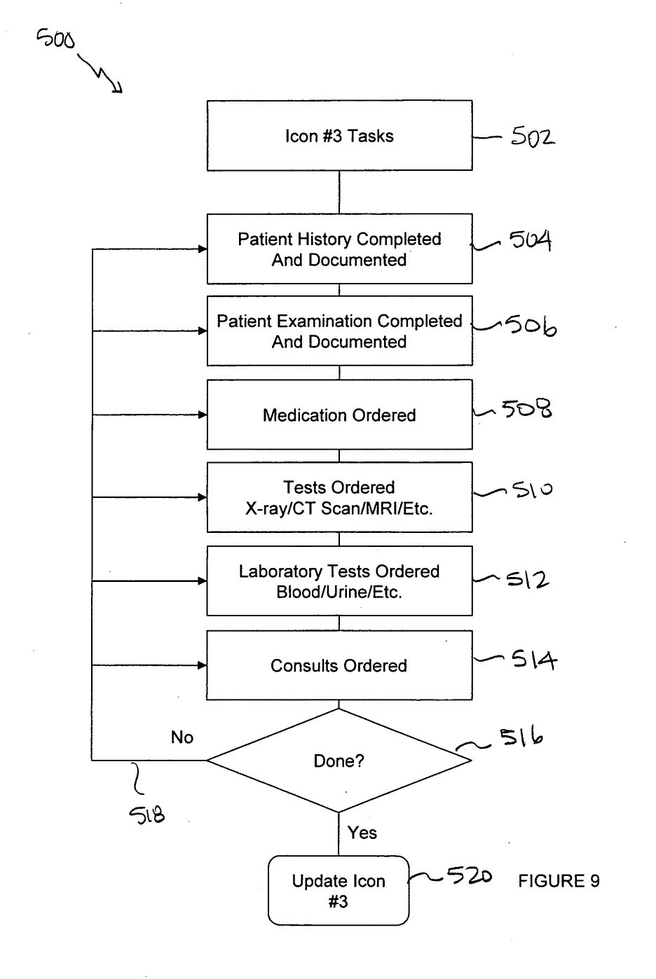

FIG. 9 is a flow chart of the operation of the system of the present invention showing the icon number 3 tasks of documenting the patient history, examination, ordering of any medications, ordering of any tests and consultations;

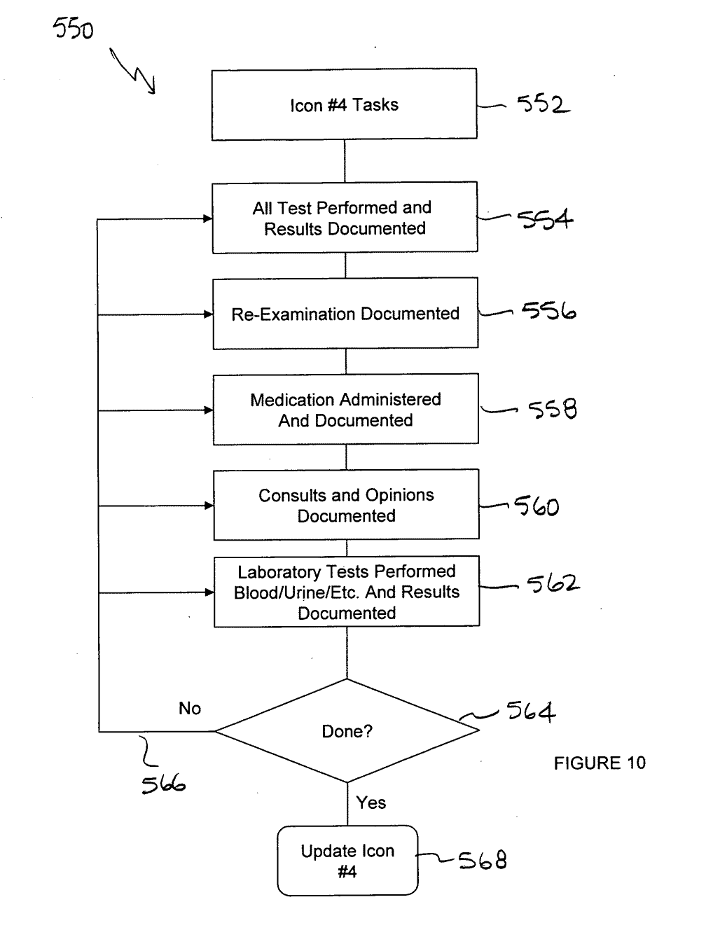

FIG. 10 is a flow chart of the operation of the system of the present invention showing the icon number 4 tasks of documenting all tests are performed and results documented, any re-examinations are documented, medications administered, consultations and opinions documented, and all results from laboratory tests are documented;

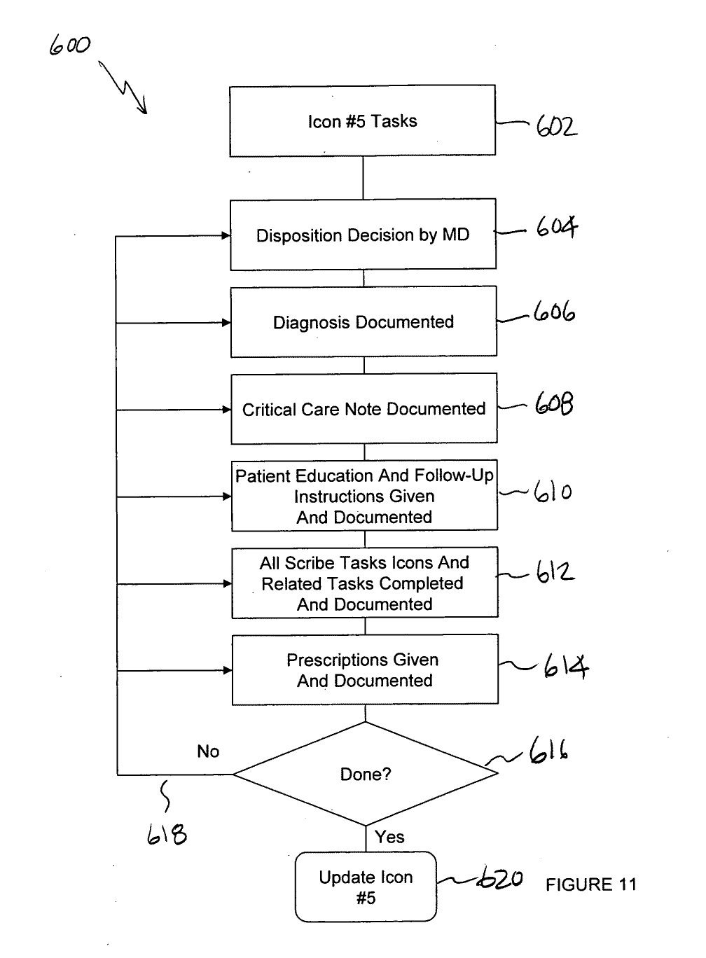

FIG. 11 is a flow chart of the operation of the system of the present invention showing the icon number 5 tasks of disposition decision and diagnosis by the MD documented, critical care notes documented, any necessary patient education and follow up instructions are given and documented, and all scribe tasks are completed and documented;

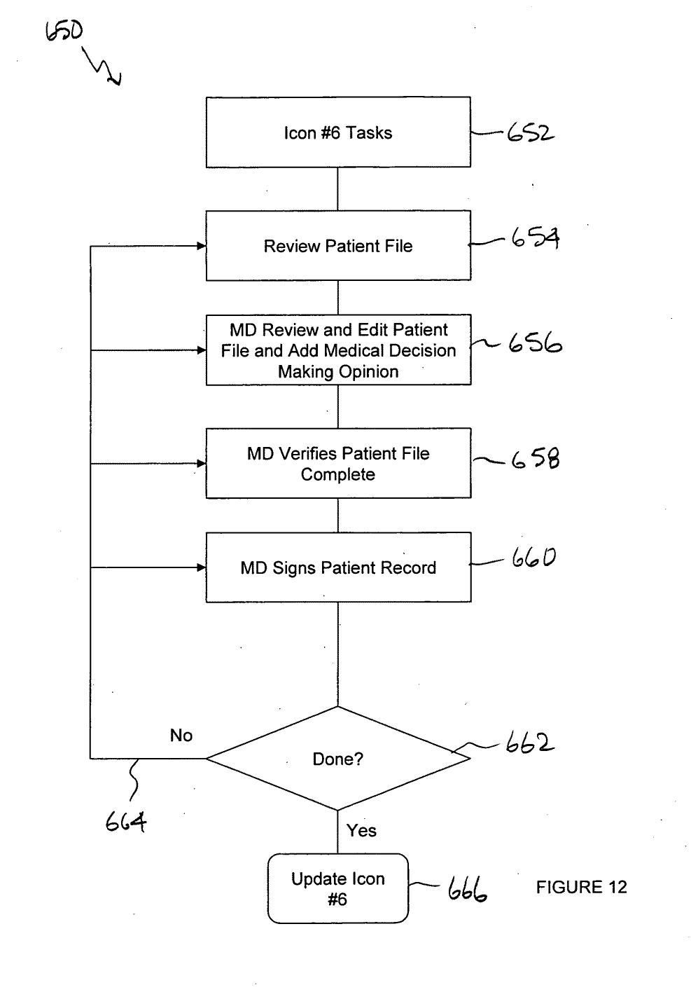

FIG. 12 is a flow chart of the operation of the system of the present invention showing the icon number 6 tasks of the MD reviewing the patient file, MD documentation of any medical decision making opinion, verification that the file is complete, and then the MD signs the patient record;

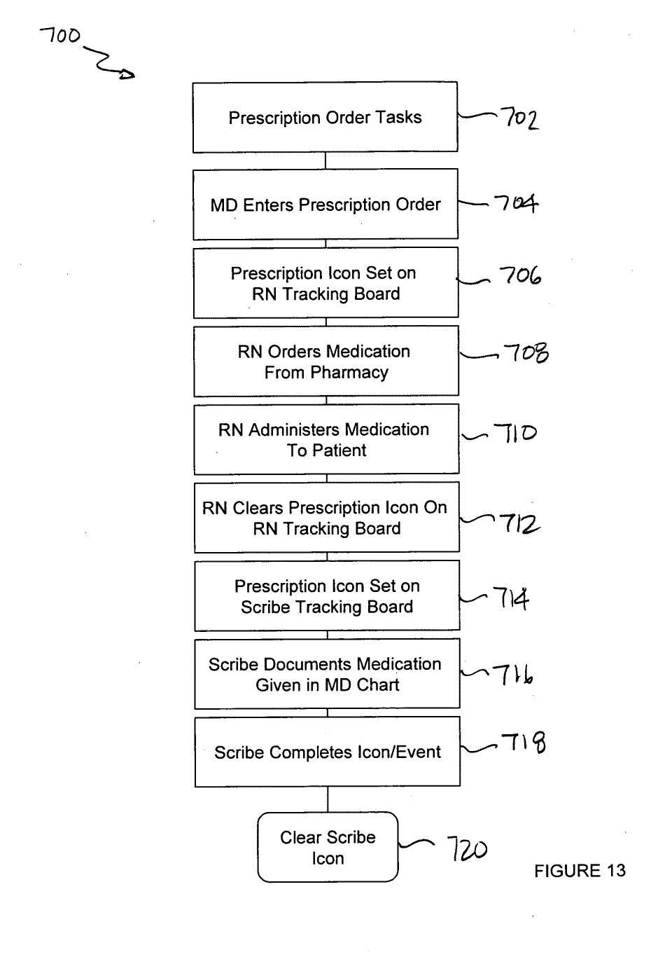

FIG. 13 is a flow chart of the operation of the system of the present invention showing the exemplary method for ordering of prescription medication including the entry of the prescription, the setting of the prescription icon on the tracking board, the ordering of the medication, administration of the medication, and the documentation by the scribe that the medication was administered to the patient;

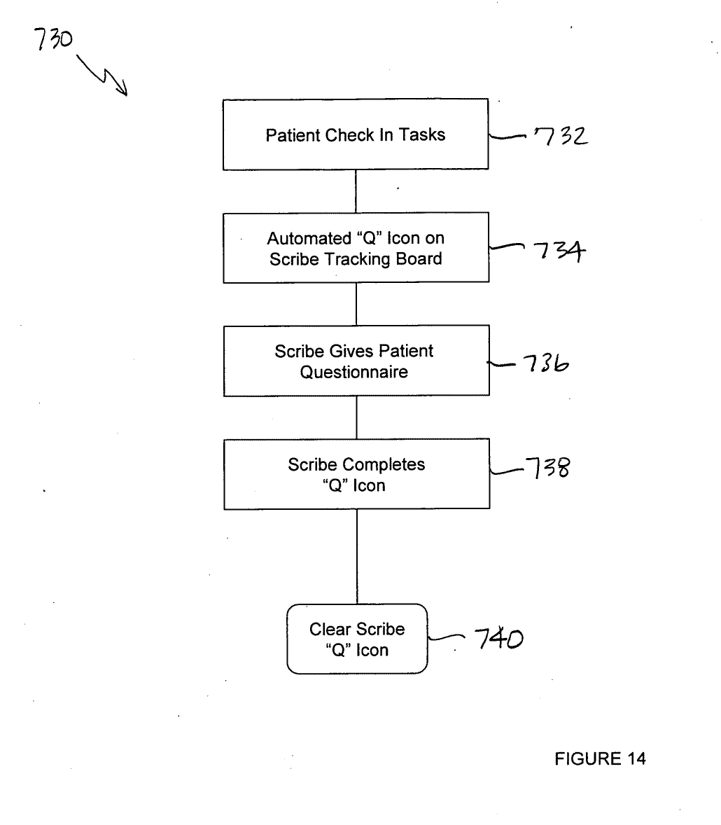

FIG. 14 is a flow chart of the operation of the system of the present invention showing the patient tasks beginning with patient check-in, including assigning a bed and giving the patient a questionnaire, and then documenting that the questionnaire was provided;

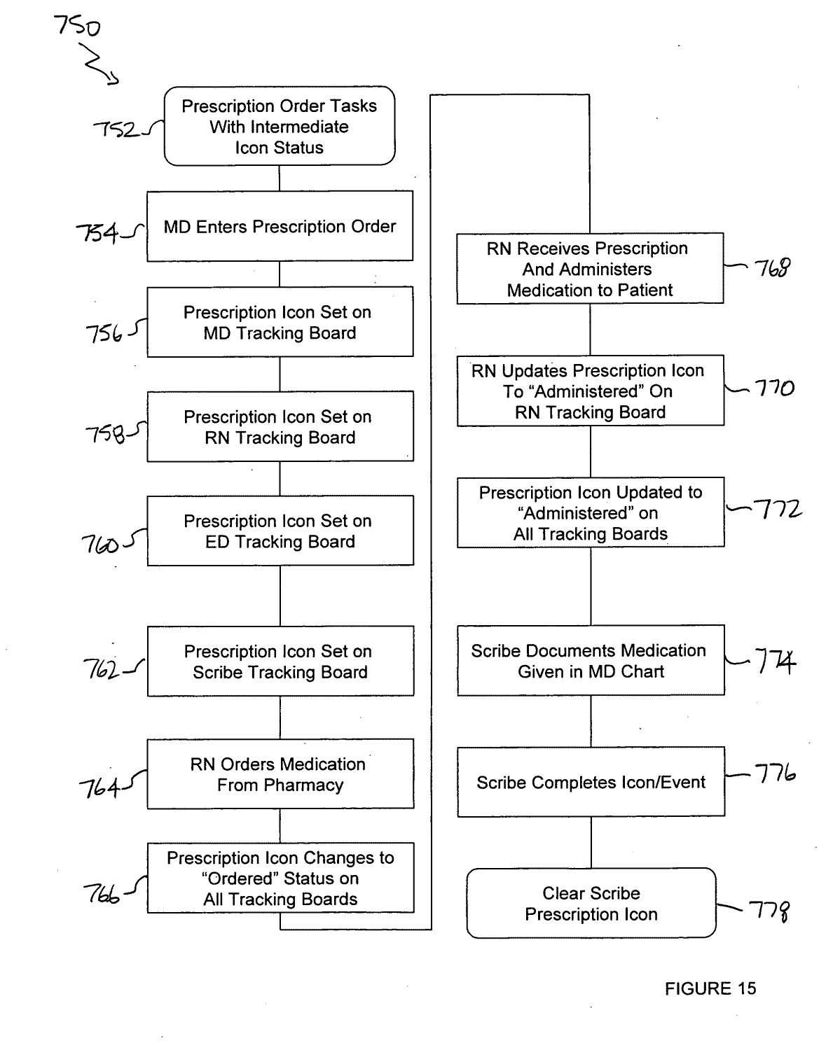

FIG. 15 is a flow chart of the operation of the system of the present invention showing a more detailed example of a prescription order utilizing the documentation method of the present invention having intermediate icon status indicators, and including the annotations on several tracking boards for the MD, nurse, scribe, etc., and the setting and clearing of icons indicating the level of completion of the task of prescribing, ordering, receiving and administering the medication to the patient;

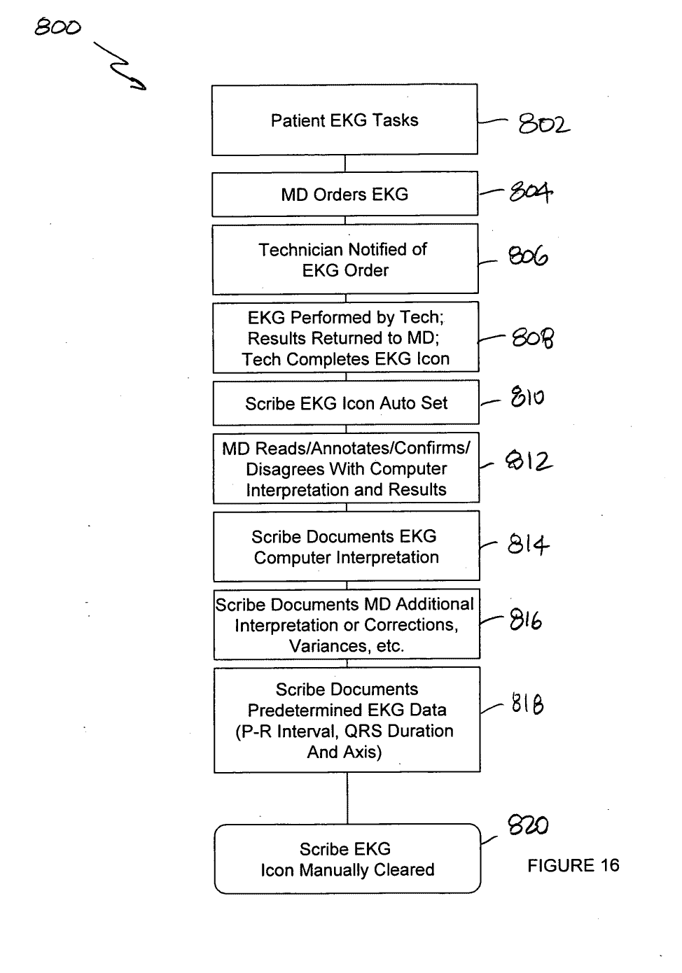

FIG. 16 is a flow chart of the operation of the system of the present invention showing the method steps for the ordering, administering and documentation of a typical EKG for a patient, including the MD ordering the EKG, the technician performing the EKG and returning the results to the MD for review and analysis, and the scribe documenting the computerized results and the MD's interpretations, corrections, or variances, as well as other predetermined EKG data; and

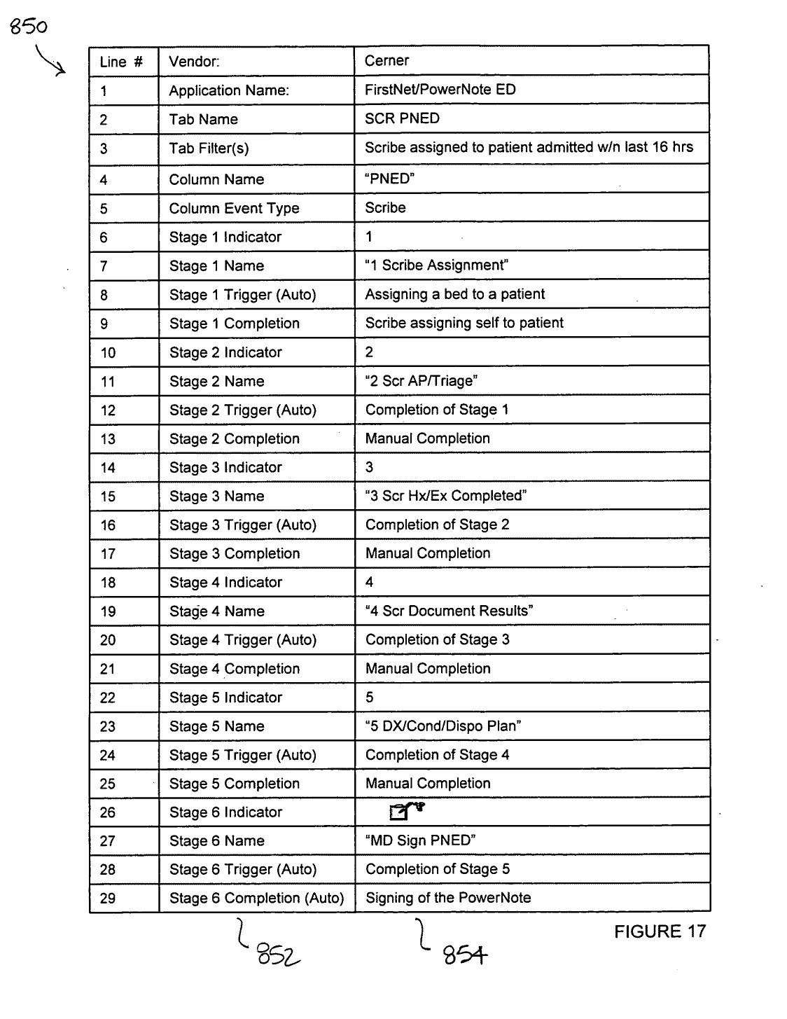

FIG. 17 is a table showing the various scribe stage indicators utilized on the tracking boards, and including the name of the stage, the tracking board indicator for that stage, the triggering or start of the stage, and the completion of the stage.

Referring now generally to the figures described above, from the views shown herein, it is seen that while the patient's name have been hidden for privacy, each patient has been identified by bed, treating physician, and general complaint, along with other data. Individual patients' identifying information is displayed on a patient tracking board in the emergency department to facilitate provider communication of relevant clinical information and tasks to be completed.

Referring to FIG. 4, an exemplary screen shot of an actual emergency department tracking board is shown and generally designated 200. In the present embodiment, this tracking board application, developed by Cerner, is called FirstNet: Note that the patient name column has been minimized for patient privacy.

The patient care column has a collection of icons 214. Each icon 214 represents a specific task that requires completion, or a necessary communication between staff in the emergency department or elsewhere in the hospital. Each icon represents an “Event” whose request time, start time, and completion time can all be time-stamped and reported on retrospectively. This becomes a tool not only for real-time communication but also for process improvement and other administrative department functions.

The FirstNet application (tracking board) is highly customizable. The basic software coding and design of the tracking board functionality was developed by Cerner Corporation. The configuration of the software, however, may be customized differently by each healthcare provider organization to fit their needs appropriately. New columns may be added, new icons and events may be created and tied to specific orders or actions within the electronic medical record. New tabs may be created (in this case the ED Station B tab 202 is selected), and each tab can be customized individually. Tab views are specific to the type of provider logged in. For example a physician will have a different view of tabs and columns when compared to a nurse's view.

This present invention includes the addition of a “PNED” column 300 within the patient tracking system that specifically tracks the stage of documentation of each patient's emergency department chart. In a preferred embodiment, this includes a linear sequence of icons numbered 1 through 5, as well as a chart signature icon. Each numeric icon 304 specifically communicates that a set of pre-defined actions have been completed by the assistant and/or physician, as well as a representation of the need for completion of the next steps in patient care and documentation for that patient. This column allows, at a glance, the physician and/or assistant to be aware of the status of documentation for all of the emergency room patients, prioritizing their next actions.

The present invention is useful in verifying that the documentation of the entire medical treatment is complete. For instance, the present invention can verify the contemporaneously documentation of the patient history and physical exam as it is being performed (real-time) by the physician, that the chart contains records of all ancillary test results and the interpretation of the results by the physician, including any lab tests, imaging tests, ECGs and ABGs. Further, the physician's consultations with family members and/or other physicians, and the review of prior medical records to obtain PMH information, and prior labs, ECG and radiographic studies for comparison can be verified and confirmed. Further, the present invention can alert a physician when a patient's chart is underdocumented, and aid with medication reconciliation documentation.

The present invention may be customized to accommodate ever-changing documentation procedures, and assist with the documentation of both standard and unique treatments performed by the physician or any other healthcare professional, including nurses and physician assistants. Further, the present invention can facilitate the documentation of lab, X-ray or other patient evaluation data and notify the physician of any ancillary tests, as well as confirm the recordation of physician-dictated diagnoses, prescriptions and instructions for patient discharge and/or follow-up.

The present invention also contemplates providing a novel scribe training tool, developed in outline form, that specifically lays out all actions a scribe must take prior to advancing one numeric icon to the next within the PNED column.

Below is the “Electronic Template Documentation—Scribe Training Tool” in its entirety (between asterisks):

### Electronic Template Documentation—Scribe Training Tool

### PNED Tasks to be Completed PRIOR to COMPLETION of Each Event/Icon: ICON #:

1. Event Name: “1 Scr Assignment”
a. SCR—R Click, “Assign Provider”
(NOTE: Event/Icon auto-completes, and changes to “2” when scribe assigns self to patient.

2. Event Name: “2 Scr AP/Triage”
a. Choose Pre-Completed Note (PCN) based on Chief Complaint on Tracking Board
b. Auto-populate Note—include ALL Available Terms
c. Basic Information:
   i. Time Seen: “Date & Time Seen”
   ii. Providers: Enter all providers that apply (ED MD, Resident, PA, PCP)
   iii. Medications: “Include Medication Profile”
   iv. Allergies: “Include Allergy Profile”
   v. Notes: Copy and Paste ENTIRE “Chief Complaint Narrative” freetext from ED Triage form into “Notes . . . ”
   vi. History: Change History Source, Arrival Mode as needed.
d. Past Medical/Family/Social History:
   i. Problem List: “Include Problem List”
   ii. Clin Notes: Include PMHx, FHx, SocHx from recent H&P's in Clin Notes
   iii. Questionnaire: Include PMHx, FHx, SocHx from patient questionnaire, modify questionnaire-based Precompleted note according to patient responses.
   iv. Save the note
(NOTE: Scribe Manually Completes #2 and #3 Auto Requests.)

3. Event Name: “3 Scr Hx/Ex Compltd”
a. SCR—Complete note through END of PHYSICAL EXAM
b. Save the note
(NOTE: Scribe Manually Completes #3 and #4 Auto Requests.)

4. Event Name: “4 Scr Docmnt Results”
a. Include Lab results from current encounter from flowsheet.
b. Copy and paste ENTIRE Radiology Result (Final results) TEXT for EVERY study of visit into:
   i. “Clinical Workup/Interpretation”:
      1. “CXR” or “CT” or “Notes” Section:
c. Check Triage form or NightHawk report for ED MD notations. Enter ED MD Xray interpretation as written. If a “P” then print “wet read” from PACS for Radiology preliminary results. Enter into powernote the results as written on the “wet read” or NightHawk report and mark on the Powernote Rad interp and macro for Nighthawk if appropriate.
   (Refer to FIG. 5 which depicts the “Set Events” Window listing multiple Scribe Task Tracking Column EVENTS (an Event is the name behind an ICON; this is where the user “completes” event to make icon disappear)
d. Review Scribe Task Tracking Column (above) and complete tasks:
   i. Document Home Medication List (from Med Rec form)
   ii. Document MD's EKG interpretation (handwritten on EKG)
   iii. Document MD or PA Procedure Notes
   iv. Questionnaire completed and collected (complete event)
   v. Document Cardiac Monitor Interpretation, if applicable (ask MD for interp)
   vi. Document all medications given in ED (from flowsheet)
   vii. Consider Critical Care Note (if prompted by event, ask MD for SYSTEM and TIME for crit. Care note)

### (Refer to FIG. 6)

e. Document MD ACTIVITY:
   i. “Documentation Reviewed” (Nurses notes, old records, etc.)—ask MD if unsure
   ii. “Re-Exam/Re-Evaluation” at time of each instance
   iii. “Calls/Consults” at time of each instance, with details and outcome of call/consult
f. Save the note
(NOTE: Scribe Manually Completes #4 and #5 Auto Requests.)

5. Event Name: “5 Scr Dx/Cond/Dispo Plan”
a. Diagnosis, Easy Script (prescriptions), patient education and discharge sections
b. MD saves note
c. MD signs note
PRINT: Notes saved but not signed report and give to MD. Remind MD to save note prior to signing. PNED MD and PNED Scribe tabs useful to open charts to be completed or signed.
   (NOTE: MD signs note at either 5 or [symbol] and both disappear.) [symbol] Event Name: “MD sign PNED”
      Many prior art problems are solved by the present invention, and include but are not limited to the following:

Communication between healthcare provider and assistant is more efficient and workflow of the scribe can now follow a pre-defined pattern, thus improving consistency in charting and delivery of patient care.

Charting is more complete and robust in content, as the assistant is automatically prompted to document numerous details of patient care that are often otherwise overlooked.

Patients' medical history information is more efficiently gathered and documented by the assistant according to answers provided by the patient.

Confusion as to who is working on what portion of charting is clarified for both the physician and the assistant, allowing a more streamlined workflow for both.

A specialized patient tracking board tab is different from the plurality of station tabs (which together comprise the overall tracking board of the present invention), in that it filters patient information in a different way. For example, a PNED MD tab just includes all patients that checked in to an ER in the past 20 hrs and therefore a physician may view all patients that day and not the previous day.

According to preferred embodiments of the present invention, some events, for example, sequenced 1-5 will trigger automatically and others will trigger manually. For example, the more simple events such as “patient arrived,” will automatically advance to the next event.

A document tracking column tracks note status. The note begins as an information gathering electronic template. By viewing the document tracking column a medical professional can indirectly track actual patient activity. A note may be a precompleted note, for example when exams are always the same. Also according to the invention, a questionnaire is completed to align with their applicable precompleted note. For example, an event including gathering past medical history will have certain questions pre-answered. These may include past medical history of hypertension, diabetes and cancer among relatives; or current and past social history such as smoking or excessive drinking.

The invention can also be characterized as a method of providing a scribe training tool comprising the note tasks explained herein to be completed prior to completion of each event.

While there have been shown what are presently considered to be preferred embodiments of the present invention, it will be apparent to those skilled in the art that various changes and modifications can be made herein without departing from the scope and spirit of the invention.

### APPENDIX 1

(26 page Appendix 1 attached)

1. A method of managing and tracking a
patient encounter comprising (the steps of):
providing a series of events, each event
representing a general status of the patient encounter; (defined below—2)
completing a task or a series of tasks associated with each of said events in series of events; and (defined below)
providing a list of automatically triggered events displayed in a scribe task tracking column, each event representing a pending task for the patient encounter; (defined below)
associating an icon with each of the said events;
advancing the status of said events based on the completing the tasks, wherein the icons visually communicate the status to a plurality of medical professionals; and
utilizing a specialized patient tracking board tab view to improve documentation tracking and completion. (not defined further yet)

2. The method of managing a patient encounter of claim 1, the series of events representing a general status of the patient encounter comprising:
a first event requesting the identifying and assigning of a scribe to said patient; (defined below)
a second event requesting scribe creating an initial note; (defined below)
a third event requesting scribe completing documenting for said patient encounter through and including history and physical examination; (defined below)
a forth event requesting scribe completing documenting results of tests, exams, and treatments for said patient encounter; (defined below)
a fifth event requesting scribe documenting diagnosis, disposition and discharge plan according to physician, and based on physician's disposition of the patient, for said patient encounter; and (defined below)
a sixth event requesting the physician completing reviewing and editing scribe's documenting, completing medical decision making documenting, and signing note. (defined below)

3. The method of managing a patient encounter of claim 2, the icons comprising:
a graphical representation of status of said single task or series of tasks related to said event;
a graphical alphanumeric sequence of symbolic representations of status of said patient encounter, linear in nature, such as 1 through 5, or A through E;
a color-coded graphical representation of status of said patient encounter; or
a linear sequence of graphical representations of status of patient encounter
or patient encounter documentation status.

4. The method of managing a patient encounter of claim 2, the general status of the patient encounter respectively comprising:
existing after initiating of said patient encounter, however prior to identifying and assigning a scribe to said patient;
existing after identifying and assigning a scribe to said patient, however prior to scribe completing the action of creating an initial note;
existing after scribe completing the action of creating an initial note, however prior to scribe completing documentation for said patient encounter through and including history and physical examination;
existing after scribe completing documentation for said patient encounter through and including history and physical examination, however prior to scribe documenting results of tests, exams, and treatments for said patient encounter;
existing after scribe completing documenting of results of tests, exams, and treatments for said patient encounter, however prior to scribe completing documenting of diagnosis, disposition and discharge plan according to physician, and based on physician's disposition of the patient; and
existing prior to scribe completing documenting of diagnosis, disposition and discharge plan according to physician based on physician's disposition of the patient, however prior to physician completing reviewing and editing scribe's documentation, completing medical decision making documentation, and signing note; and
aligning the note to seamlessly fit into the chart.

5. The method of managing a patient encounter of claim 2, the tasks of identifying and assigning a scribe to said patient comprising:
scribe assigning a provider relationship of scribe to patient who will be evaluated and treated by the physician working with said scribe.

6. The method of managing a patient encounter of claim 2, the tasks of scribe creating an initial note comprising:
distributing specialized patient medical history questionnaire to patient with request that patient fills out questionnaire to return it to scribe;
selecting and opening a customized pre-completed note based on patient's chief complaint on patient tracking board;
importing or “autopopulating” predetermined data elements (for e.g. vital signs, laboratory results, nursing notes) from current patient encounter into note;
documenting basic information in note;
documenting medical history information in note;

7. The method of managing a patient encounter of claim 6, the task of documenting basic information in note comprises:
documenting date and time of patient arrival or initiation of current encounter;
documenting date and time patient seen by physician;
documenting physician's name;
documenting scribe's name;
documenting resident physician's name, if applicable;
documenting physician assistant's name, if applicable;
documenting primary care physician's name, if applicable;
documenting specialist physician's name, if applicable;
documenting historical medication list or import medication profile from current encounter;
documenting historical allergy list or import allergy profile from current encounter;
documenting history source(s) for current encounter;
documenting arrival mode of patient for current encounter; and
importing or cutting and pasting nursing triage narrative into freetext field of note;

8. The method of managing a patient encounter of claim 6, the task of documenting medical history information in note comprises:
documenting or importing active problem list from current encounter;
documenting or importing past medical history;
documenting or importing past surgical history;
documenting or importing family history;
documenting or importing social history; and
scribe saving of document;

9. The method of managing a patient encounter of claim 8, the documenting or importing active problem list from current encounter comprises:
cutting and pasting problem list from most recent hospital admission history and physical examination, if available;
importing patient's problem list, active problem list control, or patient's active problem list profile from current encounter;

10. The method of managing a patient encounter of claim 8, the documenting or importing past medical history comprises:
documenting patient's past medical history based on patient's patient medical history questionnaire responses;
cutting and pasting past medical history from most recent hospital admission history and physical examination, if available;
importing patient's past medical history control or patient's past medical history profile from current encounter;

11. The method of managing a patient encounter of claim 8, the documenting or importing past surgical history comprises:
documenting patient's past surgical history based on patient's patient medical history questionnaire responses;
cutting and pasting past surgical history from most recent hospital admission history and physical examination, if available;
importing patient's past surgical history control or patient's past surgical history profile from current encounter;

12. The method of managing a patient encounter of claim 8, the documenting or importing family history comprises:
documenting patient's family history based on patient's patient medical history questionnaire responses;
cutting and pasting family history from most recent hospital admission history and physical examination, if available;
importing patient's family history control or patient's family history profile from current encounter;

13. The method of managing a patient encounter of claim 8, the documenting or importing social history comprises:
documenting patient's social history based on patient's patient medical history questionnaire responses;
cutting and pasting social history from most recent hospital admission history and physical examination, if available;
importing patient's social history control or patient's family history profile from current encounter;

14. The method of managing a patient encounter of claim 2, the tasks of scribe completing documenting for said patient encounter through and including history and physical examination comprising:
documenting history and physical examination or progress note of patient through the end of the physical examination portion of patient documentation;
scribe saving of document;

15. The method of managing a patient encounter of claim 2, the tasks of scribe
completing documenting results of tests, exams, and treatments for said patient encounter comprising:
documenting lab results when becoming available for said patient encounter;
documenting radiology report results when becoming available for said current patient encounter;
completing tasks associated with all events represented in the scribe task column on patient tracking board;
documenting any additional physician activities completed in relation to care of said patient during said encounter;
scribe saving of document;

16. The method of managing a patient encounter of claim 1, the list of tasks associated with events represented in the scribe task column on patient tracking board comprising:
an event requesting scribe documentation of patient's home medication list in the physician documentation portion of the electronic medical record based on documentation of medication names and dosing during medication reconciliation process;
an event requesting scribe documentation of physician's electrocardiogram interpretation in the physician documentation portion of the electronic medical record by importing results or by manual entry, based on a predetermined set of electrocardiogram data elements as well as physician interpretation;
an event requesting scribe documentation of physician assistant's procedure note in the physician documentation portion of the electronic medical record;
an event requesting scribe distribution, collection and documentation of a custom patient history questionnaire designed to correlate with custom pre-completed note content in the physician documentation portion of the electronic medical record;
an event requesting scribe documentation of a respiratory therapy treatment in the physician documentation portion of the electronic medical record;
an event requesting scribe documentation of a medication given to a patient during said encounter in the physician documentation portion of the electronic medical record;
an event requesting scribe documentation of a physician consultation conversation during said encounter in the physician documentation portion of the electronic medical record;
an event requesting scribe documentation of an ancillary study result in the physician documentation portion of the electronic medical record;
an event requesting the scribe confer with the physician as to whether said patient is appropriate for a critical care note or not, and if so then the scribe documenting a critical care note based on physician direction in the physician portion of the electronic medical record upon completion of an order that may be associated with a critical care patient;

17. The method of managing a patient encounter of claim 1, the automation of the said list of events representing a pending task in the scribe task column for the patient encounter comprising:
the triggering of an event requesting scribe documentation of patient's home medication list in the physician documentation portion of the electronic medical record, based on documentation of medication names and dosing during medication reconciliation process upon completion and signature of the electronic home medication list form during the medication reconciliation process;
the triggering of an event requesting scribe documentation of physician's electrocardiogram interpretation in the physician documentation portion of the electronic medical record upon completion of the electrocardiogram order in the electronic medical record;
the triggering of an event requesting scribe documentation of physician assistant's procedure note in the physician documentation portion of the electronic medical record upon the completion of the event indicating a pending status of the procedure;
the triggering of an event requesting scribe distribution, collection and documentation of a custom patient history questionnaire designed to correlate with custom pre-completed note content in the physician documentation portion of the electronic medical record upon completion of the arrival event at the initiation of the patient encounter;
the triggering of an event requesting scribe documentation of a respiratory therapy treatment in the physician documentation portion of the electronic medical record upon respiratory therapist completion of the respiratory therapy treatment order in the electronic medical record;
the triggering of an event requesting scribe documentation of a medication given to a patient during said encounter in the physician portion of the electronic medical record upon completion of the said medication order in the electronic medical record;
the triggering of an event requesting scribe documentation of a physician consultation conversation during said encounter in the physician portion of the electronic medical record upon completion of the event indicating pending status of physician consultation conversation;
the triggering of an event requesting scribe documentation of an ancillary study result in the physician portion of the electronic medical record upon changing of the status of the said ancillary study result from pending to complete; and
the triggering of an event requesting the scribe confer with the physician as to whether patient is appropriate for a critical care note or not, and if so then the scribe documenting in the physician portion of the electronic medical record upon completion of an order that may be associated with a critical care patient;

18. The method of managing a patient encounter of claim 16, after automatically prompting by the scribe electrocardiogram documentation event, the predetermined set of electrocardiogram data elements and physician interpretation to be documented by the scribe in the electronic medical record by importing results or by manual entry, based on a predetermined set of electrocardiogram data elements as well as physician interpretation comprise:
choosing appropriate pre-completed electrocardiogram basic physician interpretation macro based on whether an old electrocardiogram is available or not, and whether there is a change from old electrocardiogram or not;
documenting date and time of electrocardiogram;
documenting electrocardiogram rate;
documenting electrocardiogram PR interval;
documenting electrocardiogram QRS duration time interval;
documenting electrocardiogram QTc interval;
documenting those electrocardiogram computer rhythm interpretations, or portions thereof, noted for inclusion by physician by way of checking, circling, or underlining on paper electrocardiogram;
not documenting those electrocardiogram computer rhythm interpretations, or portions thereof, not noted for inclusion by physician by way of checking, circling, or underlining on paper electrocardiogram;
not documenting those electrocardiogram computer rhythm interpretations, or portions thereof, noted for exclusion by physician by way of single line strike-through on paper electrocardiogram;
documenting any additional physician electrocardiogram interpretations as noted in writing by physician on paper electrocardiogram;
documenting interpretation completed by physician;
indicating scribe completion of physician electrocardiogram interpretation documentation in the electronic medical record by way of initialing the upper right corner of the paper electrocardiogram; and
completing the scribe electrocardiogram documentation event;

19. The method of managing a patient encounter of claim 16, after prompting by the scribe physician assistant procedure note documentation event, the scribe documentation of a physician assistant's procedure note in the physician documentation portion of the electronic medical record comprises:
creating an addendum note for said patient with the purpose of documenting a physician assistant's procedure note;
inserting the appropriate procedure note template based on information obtained from the physician assistant who completed the procedure;
documenting procedure note details based on information obtained from the physician assistant who completed the procedure;
triggering the physician assistant procedure note to review and sign event on the tracking board when physician assistant procedure note is ready to be reviewed, edited and signed by physician assistant; and
completing the scribe physician assistant procedure note documentation event;

20. The method of managing a patient encounter of claim 16, after automated prompting by the scribe questionnaire event at the time of arrival, scribe distribution of questionnaire, collection and documentation of information obtained from patient using a custom patient history questionnaire designed to correlate with custom pre-completed note content in the physician documentation portion of the electronic medical record comprises:
distributing patient history questionnaire to every patient or patient family on patient arrival or at outset of encounter;
assisting patient in completing said questionnaire if they require assistance;
collecting patient history questionnaire from patients when they have been completed;
handing completed patient history questionnaire to physician for review prior to documenting patient questionnaire responses in electronic medical record;
documenting patient questionnaire responses in electronic medical record; and
completing the scribe questionnaire event;
